(19) United States
(12) Patent Application Publication
(10) Pub. No.: US 2014/0344325 A1
(43) Pub. Date: Nov. 20, 2014

(54) ASYNCHRONOUS CONTENT UPDATES IN THE BACKGROUND FOR IMPROVED APPLICATION PERFORMANCE

(71) Applicant: Martin Moser, Speyer (DE)

(72) Inventor: Martin Moser, Speyer (DE)

(73) Assignee: SAP AG, Walldorf (DE)

(21) Appl. No.: 13/895,074

(22) Filed: May 15, 2013

(51) Int. Cl. H04L 29/06

(52) U.S. Cl. CPC H04L 67/42
USPC 709/203

(57) ABSTRACT

Server loads can be reduced while improving the experience for a user of a web application in which one or more images are produced at a server and transmitted over a communication channel to a client device. In some examples, navigation by a user to an application page that contains an image or other content resource that requires generation by a backend server but that might not immediately interest the user can involve an asynchronous download of the content resource to the client machine. In some variations, the asynchronous download can occur after a user input requesting an updating of the content resource initially displayed based on a cached resource.

### TECHNICAL FIELD

The subject matter described herein relates broadly to images or other content generated at a server machine and displayed to a user at a client machine.

### BACKGROUND

When a user navigates a browser or other software application for displaying or viewing content downloaded from a server (hereinafter generically referred to as a browser) to a page that contains an image or other content that is expensive to produce, for example in terms of consumption of computing resource resources such as processor cycles, memory, network bandwidth, etc. Examples of “expensive” images or other content can include, but are not limited to, charts utilizing business intelligence data or otherwise being dynamically generated as underlying data changes through ongoing use of a business software application or applications. A conventional approach to providing this kind of content to client machines is to have the image rendered at a server machine, and displayed in the browser. However, such an approach can include one or more disadvantages. For example, while navigating to a page in a series of pages, a user may first reach an intermediate page that includes some additional content. The user may require only the ability to access a navigation link on the intermediate page that leads to a next page in the series and therefore be uninterested in the content of the image or whether that content reflects a fully updated state of any data underlying the content. In this situation, if the content is automatically refreshed upon loading of the page, computational resources are wasted to create unneeded content. Additionally the user experience can be negatively impacted by psychological factors such as being discouraged from proceeding on to the next page in the series while the content has not been completely loaded in the intermediate page.

### SUMMARY

Consistent with implementations of the current subject matter, an improved user experience (e.g. a better perceived performance of a Web application, particularly but not exclusively a web application provided on a mobile device or other client machine remote from the Web server) can be provided, and server loads can, in some implementations, be reduced by using resources from the cache to initially display a page or screen that the user has navigated. The application cache 120 (which can optionally be a HTML5 application cache) can request from the server a validation or verification that the cached resources are current relative to data maintained at the server. If the cached resources are not current, one or more optional approaches can be applied to obtain updated versions of the cached resources from the server.

In one aspect, a method includes displaying a content resource concurrently with an initial presentation of an application page at a client machine, determining a validity of the cached resource relative to a current state of data in one or more databases, and updating the cached resource if a cached resource at the client machine is determined to be invalid relative to the current state of the data. The displaying includes accessing the cached resource, which is representative of the content resource. The content resource is provided by a backend server to the client machine based on data in one or more databases. The updating includes an asynchronous call from the client machine to the backend server that occurs while the content resource based on the cached resource is displayed by the client machine as part of the application page. The method further includes replacing the content resource with a new version of the content resource after completion of the asynchronous updating.

In some variations, one or more of the following features can optionally be included in any feasible combination. The determining of the validity of the cached resource can include determining whether the backend server is capable of generating the new current version of the content resource. The updating can further include receiving the new version of the content resource. The cached resource can include at least one of a previous version of the content resource downloaded to the client machine from the backend server during a previous display of the application page at the client machine, a blank shape, and a dummy image. The updating can occur in response to receipt of a user input or the updating can occur automatically upon determining that the cached resource is invalid relative to the current state of the data. The replacing can occur in response to receipt of a user input or automatically upon completion of the updating.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to an enterprise resource software system or other business software solution or architecture, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 shows a diagram illustrating aspects of a system framework showing features consistent with implementations of the current subject matter;

FIG. 2 shows a screenshot view illustrating features relating to a manual update approach consistent with implementations of the current subject matter;

FIG. 3 shows another screenshot view illustrating features relating to the manual update approach consistent with implementations of the current subject matter;

FIG. 4 shows another screenshot view illustrating features relating to the manual update approach consistent with implementations of the current subject matter;

FIG. 5 shows a screenshot view illustrating features relating to a semi-automatic update approach consistent with implementations of the current subject matter;

FIG. 6 shows another screenshot view illustrating features relating to the semi-automatic update approach consistent with implementations of the current subject matter;

FIG. 7 shows another screenshot view illustrating features relating to the semi-automatic update approach consistent with implementations of the current subject matter;

FIG. 8 shows another screenshot view illustrating features relating to an automatic update approach consistent with implementations of the current subject matter;

FIG. 9 shows another screenshot view illustrating features relating to the automatic update approach consistent with implementations of the current subject matter; and

FIG. 10 is a process flow diagram illustrating aspects of a method having one or more features consistent with implementations of the current subject matter.

When practical, similar reference numbers denote similar structures, features, or elements.

### DETAILED DESCRIPTION

Implementations of the current subject matter can, among other possible advantages, provide capabilities relating to reducing server loads while also improving a user experience, in particular relating to loading of dynamically generated content provided via a server or otherwise conveyed to a client machine via a network or other data connection. In some examples, an application cache, such as is featured in the new HTML5 standard, can be leveraged to allow a more intelligent approach to serving “expensive” content to a client machine, in particular when it may not be necessary. Some implementations of the current subject matter can be well suited for mobile devices (e.g. smartphones, tablet computers, laptop computers, etc.), as the available bandwidth on such devices can often be limited relative to desktop computers.

In contrast to HTML4, HTML5 implementations in many browser applications can support functionality referred to as an application cache. The application cache is a feature to store resources of Web applications on the client itself, which can allow a developer a better control of how the resources in the cache are used. For example, in HTML5, definitions of files are not purged from the cache via the cache manifest, asynchronous updates of the application cache are possible, and programmatic control of updates of screen contents from the cache are enabled. Other standards for web applications, mobile apps, and the like may include such capabilities.

A user experience (which can be realized in the form of perceived performance) can be improved and resources of a server providing content resources (e.g. a web page, an image, etc., hereinafter referred to as served content) can be more efficiently deployed by displaying the web page immediately using content resources stored locally on the client machine, for example in an application cache. Content resources stored locally at the client machine are referred to in this document as “cached resources.” A content resource stored locally and determined to be out of date or otherwise not fully current relative to the underlying data presented in the content resource is referred to as an updatable cached resource. A request can be conveyed to the server, for example using functionality of the application cache, for updated versions of the cached resources. If the server indicates that some of the content resources necessary for fully rendering a web page or particular view in an application are available in a more recent version than the corresponding updatable cached resource retained at the client machine, the client machine can provide a user interface indication that a more recent version of the content resource is available for download from the server.

At design time of a web application, (e.g. by a developer, a member of a development team, etc.) a setting can be established to define how content resources are handled at runtime. Options for content resources display parameters to be applied at runtime can include determining whether to have updated versions of an updatable content resource downloaded asynchronously and displayed immediately, downloaded asynchronously and displayed per the user's request, or both downloaded and displayed per the user's request. Additionally, the user may override the default behavior chosen by the developer using a personalization feature of a web page or other networked application, which are referred to generically in this document as an application.

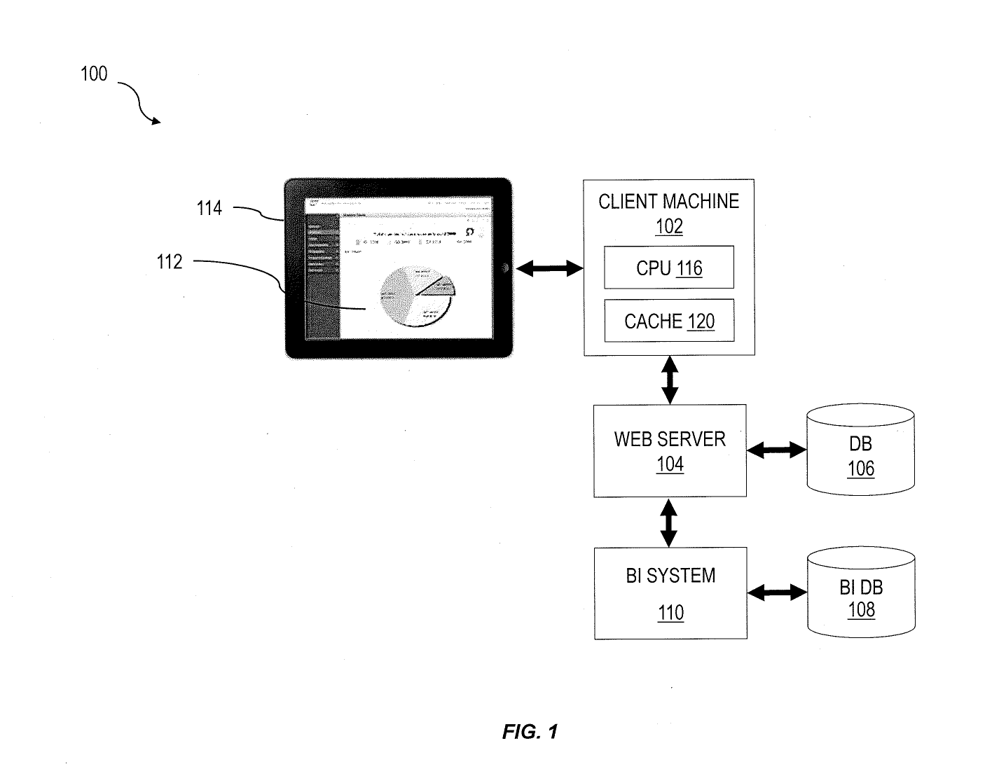

FIG. 1 shows a diagram illustrating an example of components that can be present in a framework supporting an application that delivers dynamic content to an application executed on a client machine. In reference to FIG. 1, an application for execution on a mobile device 102 can be built on a Web server 104 that stores data in its own database 106, and accesses business intelligence (BI) data in a second database 108 of a BI system 110 accessible to it. The application can include at least one application page 112 for display to a user via a display or display device 114 that is part of or that receives video output from the client machine 102. The application page 112 can include one or more content resources such as an image displaying a visual representation of BI data collected by the Web server 104 from the BI system 110 and rendered at the Web server 104 to be served over a network connection to the mobile device 102. The mobile device 102 can also include a processor (e.g. a central processing unit or CPU) 116. An application cache 120 can be retained in memory or on some other storage device that is part of or accessible to the client machine 102. The client machine can also include or receive inputs from one or more user input devices, such as for example a touch-sensitive screen as shown in FIG. 1. Other input devices can include a mouse, a stylus, a trackball, a pointer, etc.

Three example approaches for providing a new version of an updatable content resource within a page visited by a user of an application are described below. These approaches, which are respectively referred to below as manual update, semi-automatic update, and automatic update, are illustrative. Other approaches may be possible within the scope of the current subject matter.

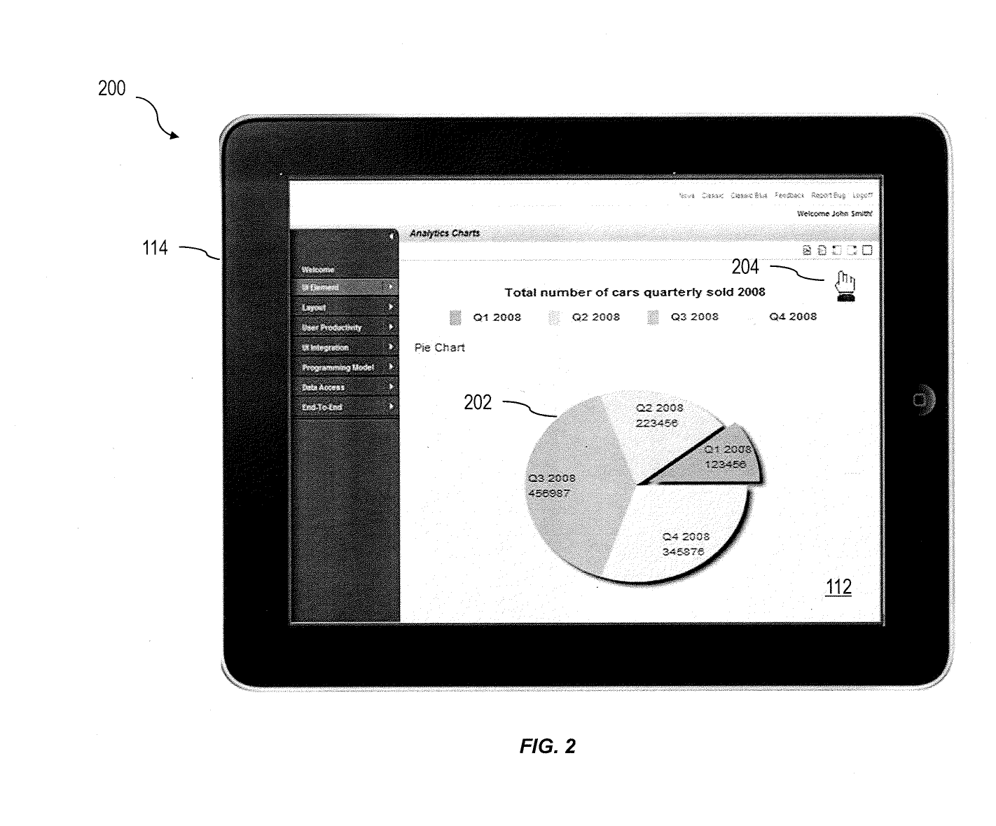

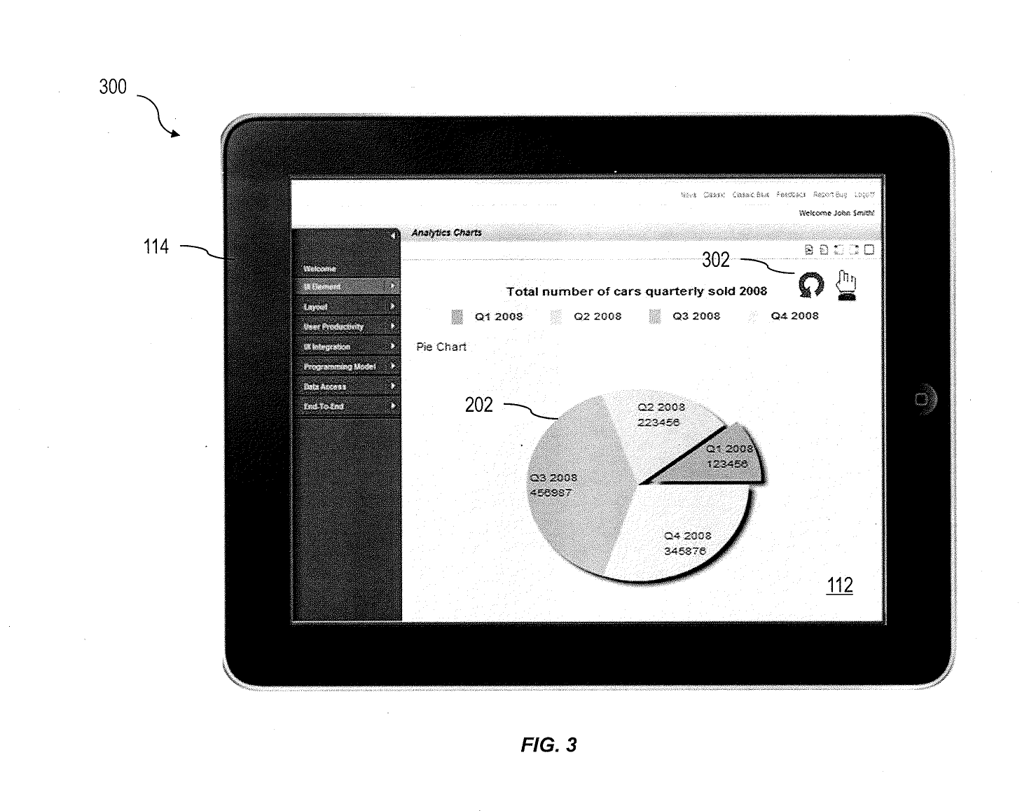

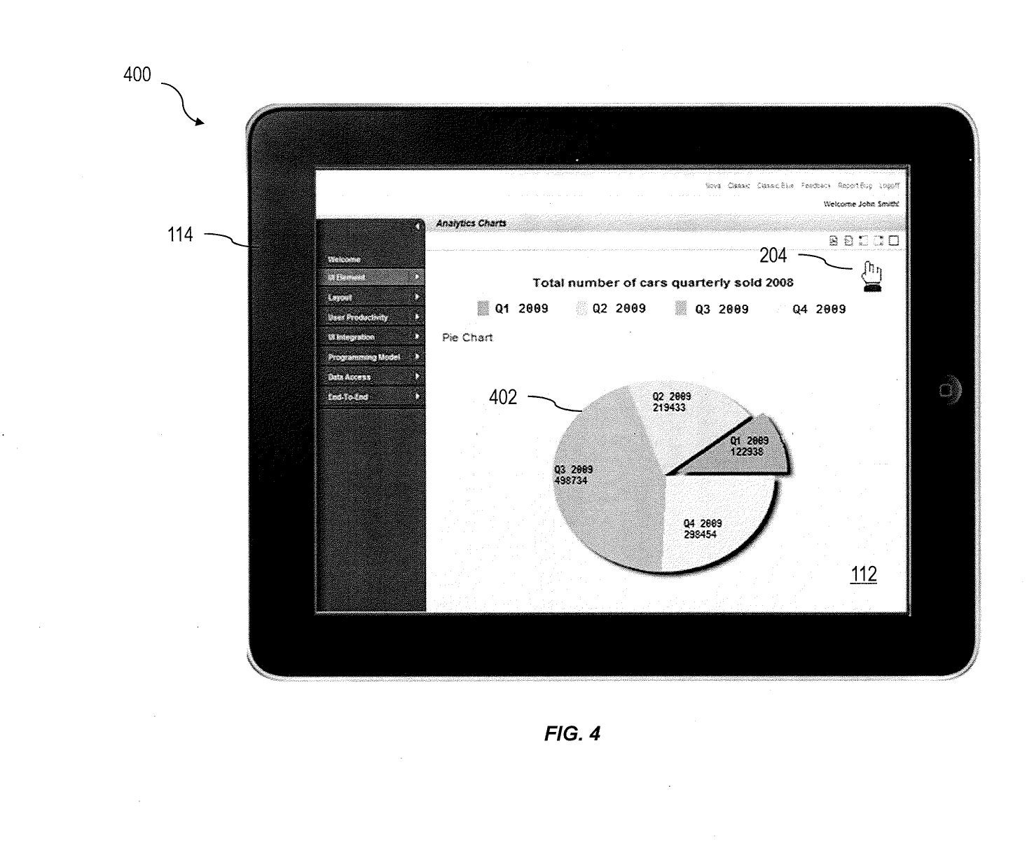

An example of the manual approach is illustrated in the screenshot views 200, 300, and 400 of FIG. 2, FIG. 3, and FIG. 4, respectively. An application page 112 is loaded from the web server 104 (see FIG. 1) and displayed on a display device 114. The application page 112 includes a content resource 202 (in this example, a pie chart) that is generated based on data (e.g. BI data accessed from a BI database 108 of a BI system 110) that can change over time. On a first navigation to the application page 112 with the client machine (or on a first navigation to the application page 112 with a specific browser application of a plurality of browser applications on the client machine 102), the content resource 202, as well as one or more other features displayed on the application 112 or optionally all of the features displayed on the application page 112 can be stored in an application cache 120 or other local storage at the client machine 102 upon being received from the web server 104.

If the application page 112 is loaded subsequently to a first downloading of the application page 112, the cached resource is accessed from the application cache 120 to quickly present the application page 112 including the content resource 202 based on the cached resource. The cached resource is also validated using the application cache 120. This validation can include determining whether the cached resource is representative of a current state of the data presented in the content resource 202. If the validation indicates that the cached resource is current, up-to-date, etc. with the underlying database 108, the application page 112 is presented as it would be under an existing approach. However, if the validation indicates that the Web server 104 is capable of generating a more recent version of the content resource 202 than that based on the cached resource at the client machine 102, a manual reload user interface element 204 can be displayed on the application page 112 as shown in the screenshot view 200 of FIG. 2. The manual reload user interface element 204 can optionally be displayed near, on, or otherwise associated with the displayed content resource 202, and can indicate that the displayed content resource 202 can be updated to reflect more current underlying data that it currently displays. The manual reload user interface element 204 can include one or more of a selectable update available indicator such as a reload icon or button, clickable text indicating that an updated version of the content resource 202 is available, or the like.

If the user selects the manual reload user interface element 204, the application cache 120 is requested to load a new version of the content resource 402 asynchronously from the Web server 104. To indicate that an update is in progress, an in-progress user interface element 302 (e.g. an update in-progress indicator such as a rotating arrow of the like) can be displayed as shown in the screenshot view 300 of FIG. 3. Optionally, the in-progress user interface element 302 can replace the manual reload user interface element 204 or be displayed concurrently with the manual reload user interface element 204. Once the new version of the content resource 402 has been loaded from the Web server 104, this new version is displayed on the application page 112 as shown in the screenshot view 400 of FIG. 4, and the in-progress user interface element 302 is no longer displayed, thereby indicating that the displayed new version of the content resource 402 is a current representation of the underlying data. The new version of the content resource 402 also replaces the cached resource in the application cache 120 at the client machine 102 such that a subsequent loading of the application page 112 can proceed in the manner outlined above. In this manner, the load on the Web server 104 and bandwidth usage between the Web server 104 and the client machine 102 can be reduced (e.g. if the new version of the content resource is not requested by the user) and the application page 112 can be rendered more quickly as the content resource is first loaded from the application cache 120, rather than from the Web server 104, upon navigation to the application page 112. Loading of the new version of the content resource 402 from the Web server 104 is only performed if requested via a user input, such as for example selecting of the manual reload user interface element 204 as described above.

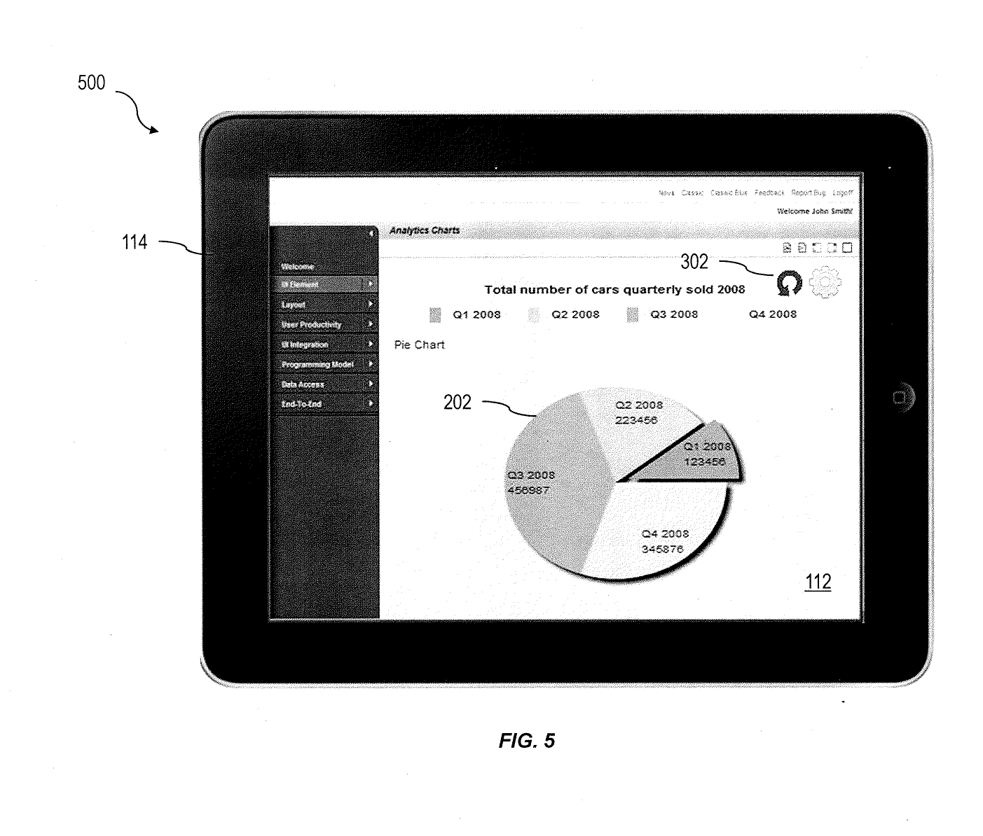

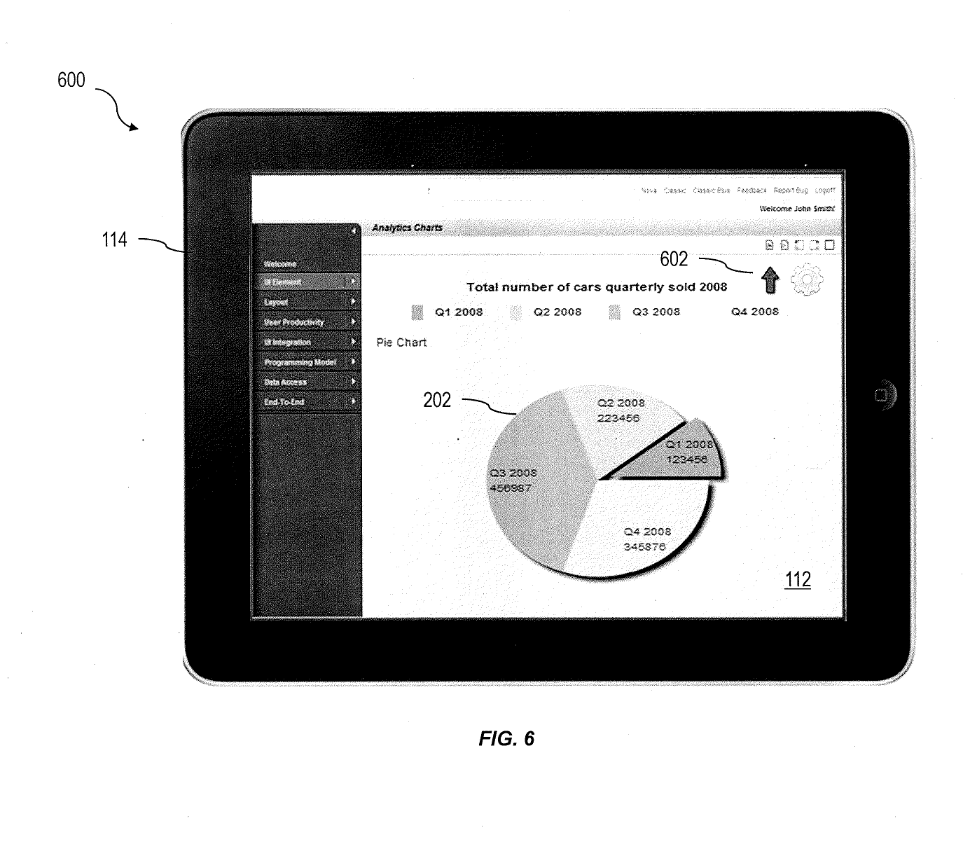

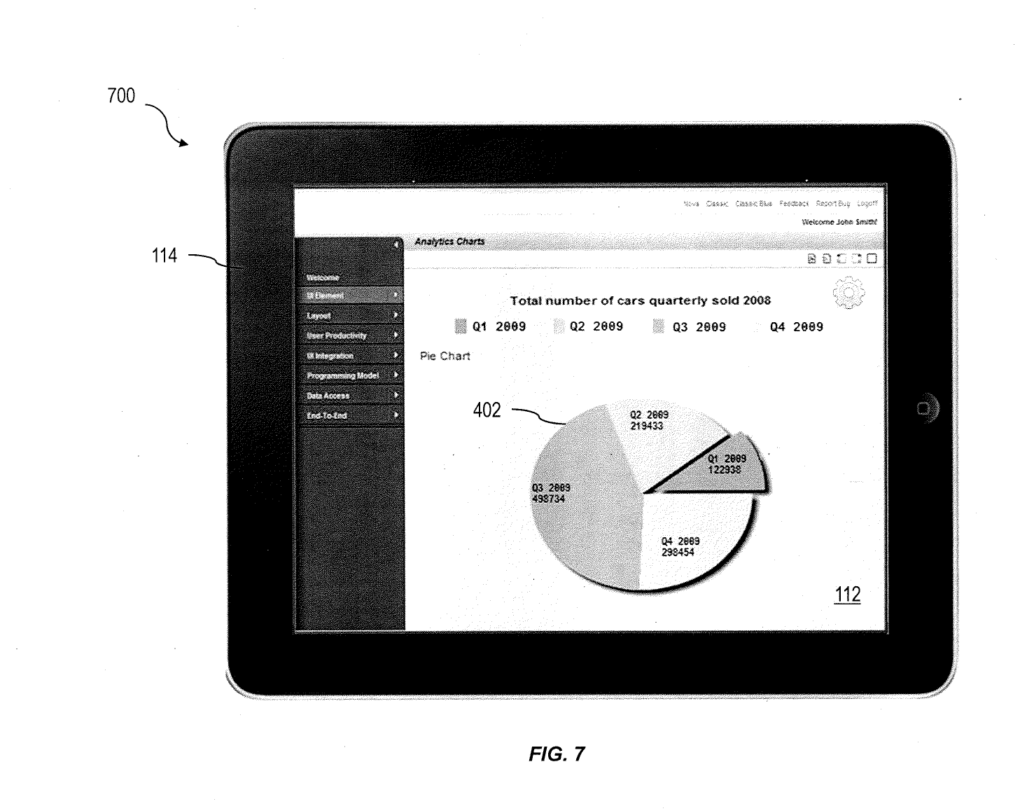

An example of the semi-automatic approach is illustrated in the screenshot views 500, 600, and 700 of FIG. 5, FIG. 6, and FIG. 7, respectively. Similar to the manual approach described above, the application page 112 is loaded from the Web server 104 and displayed, and the content resource 202 stored in the application cache 120 as a cached resource is loaded from the cache 120 and displayed as part of the application page 112. Additionally, the validity of the displayed content resource 202 is validated using the application cache 120. This validation can include determining whether the cached resource is representative of a current state of the data presented in the content resource 202. If the validation indicates that the cached resource is current, up-to-date, etc. with the underlying database 108, the application page 112 is presented as it would be under an existing approach. However, if the validation indicates that the Web server 104 could generate a more recent version of the content resource 202, an asynchronous download of a new version of the content resource 402 is initiated in the background while the application page 112 is displayed using the content resource 202 loaded using the cached resource. An in-progress user interface element 302 is displayed, for example as shown in the screenshot view 500 of FIG. 5, to indicate that the download is in progress. Once the asynchronous download of the new version of the content resource 402 completes, the in-progress user interface element 302 is replaced by a refresh user interface element 602 as shown in the screenshot view 600 of FIG. 6. When the refresh user interface element 602 is selected or otherwise activated by a user, the initially displayed content resource 202 is replaced by the newly downloaded new version of the content resource 402, and the refresh user interface element 602 is no longer displayed, as shown in the screenshot view 700 shown in FIG. 7.

Replacing the initially displayed content resource 202 with the new version of the content resource 402 downloaded from the Web server 104 can optionally be accomplished using a fading effect or other approach to avoid potentially unwelcome flicker of the UI. Using this semi-automatic approach, a complete (albeit potentially not fully up-to-date) version of the application page 112 can be displayed more quickly due to loading of the content resource 120 based on the cached resource stored in the application cache 120. However, the load on the Web server 104 and bandwidth usage between the Web server 104 and the client machine 102 is not reduced, as the new version of the content resource 402 is generated and downloaded in the background to the application cache 120 without waiting for the user to request the download.

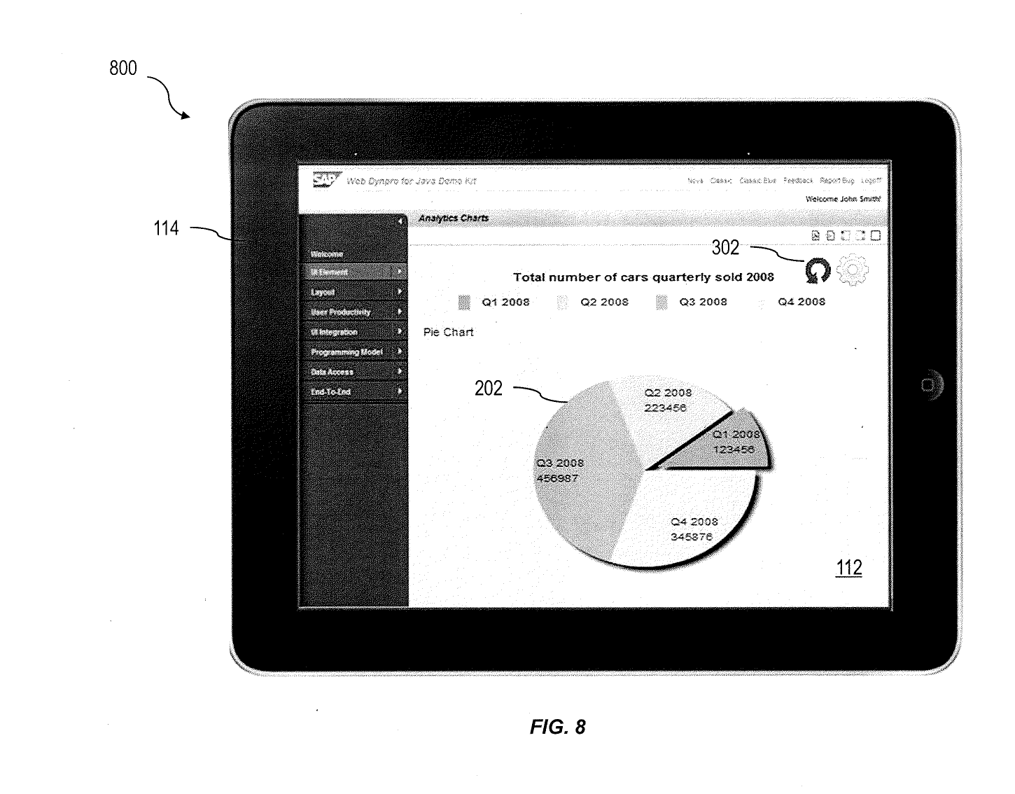

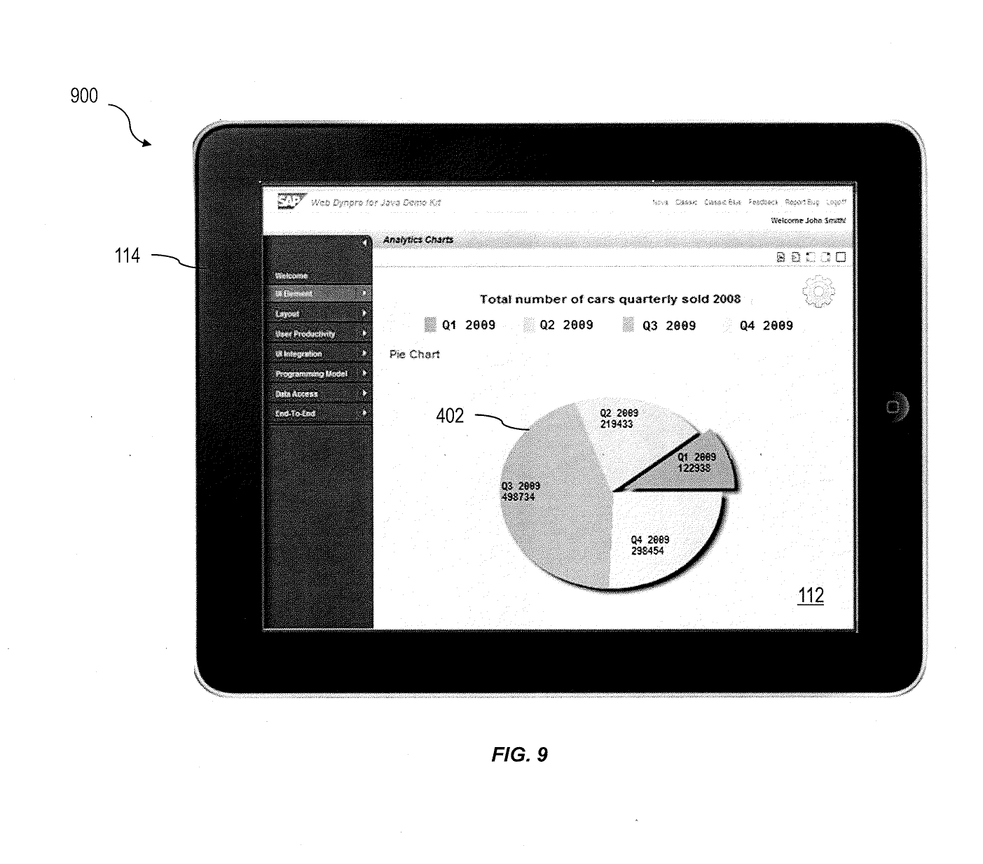

An example of the automatic approach is illustrated in the screenshot views 800 and 900 of FIG. 8 and FIG. 9, respectively. Similar to the manual and semi-automatic approaches described above, the application page 112 is loaded from the Web server 104 and displayed, and the content resource 202 stored in the application cache 120 as a cached resource is loaded from the cache 120 and displayed as part of the application page 112. Additionally, the validity of the displayed content resource 202 is validated using the application cache 120. This validation can include determining whether the cached resource is representative of a current state of the data presented in the content resource 202. If the validation indicates that the cached resource is current, up-to-date, etc. with the underlying database 108, the application page 112 is presented as it would be under an existing approach. However, if the validation indicates that the Web server 104 could generate a more recent version of the content resource 202, an asynchronous download of a new version of the content resource 402 is initiated in the background while the application page 112 is displayed using the content resource 202 loaded using the cached resource. An in-progress user interface element 302 is displayed, for example as shown in the screenshot view 800 of FIG. 8, to indicate that the download is in progress. Once the asynchronous download of the new version of the content resource 402 completes, the initially displayed content resource 202 is replaced by the newly downloaded new version of the content resource 402, and the in-progress user interface element 302 is no longer displayed, as shown in the screenshot view 900 shown in FIG. 9.

Replacing the initially displayed content resource 202 with the new version of the content resource 402 downloaded from the Web server 104 can optionally be accomplished using a fading effect or other approach to avoid potentially unwelcome flicker of the UI. Using this automatic approach, a complete (albeit potentially not fully up-to-date) version of the application page 112 can be displayed more quickly due to loading of the content resource 120 based on the cached resource stored in the application cache 120. However, the load on the Web server 104 and bandwidth usage between the Web server 104 and the client machine 102 is not reduced, as the new version of the content resource 402 is generated and downloaded in the background to the application cache 120 without waiting for the user to request the download.

The descriptions above describe display of a cached resource retrieved from an application cache 102 or the like at the client machine with an initially presented view of the application page. Optionally, on a first visit by the client machine 102 or by a new Web browser application, etc. to an application page 112, a dummy image, a blank window, or the like can be presented where the content resource 202 would be if it were available. In this manner, even on a first visit to an application page, the advantages of rapid loading of the application page, and in some examples reduced Web server loads and bandwidth demands, can be realized, even if the application page 112 has not previously visited.

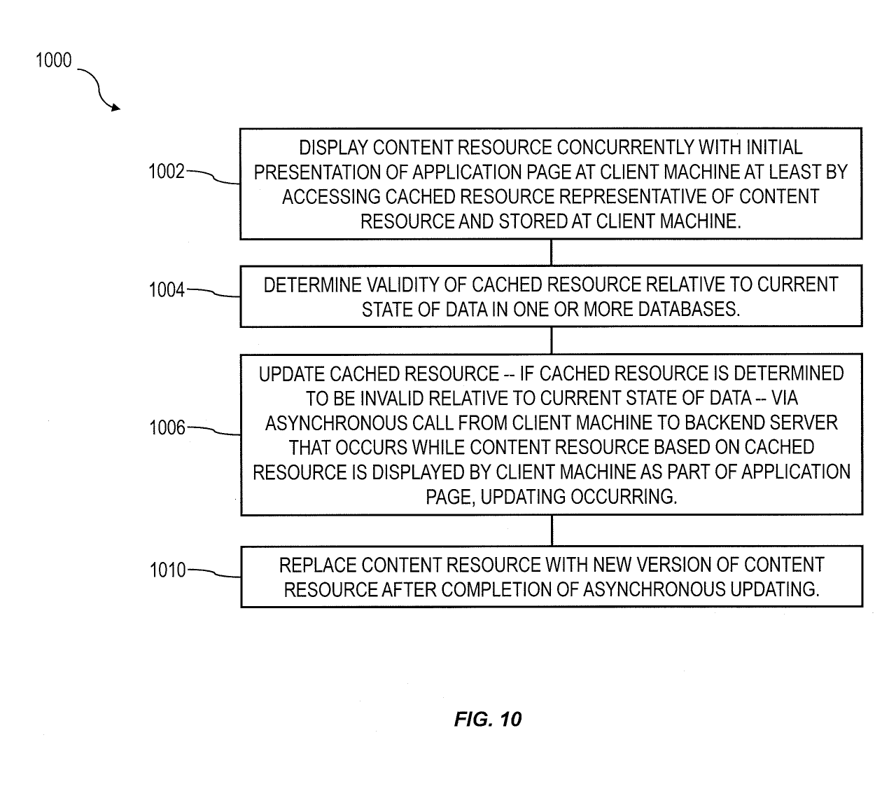

FIG. 10 shows a process flow chart 1000 illustrating features of a method consistent with an implementation of the current subject matter. One or more of these features can be included in other implementations. At 1002, upon navigation at a client machine to an application page comprising a content resource generated by a backend server (e.g. a Web server 104), a cached resource representative of the content resource is displayed as part of an initial presentation of the application page at the client machine 102. A validity of the cached resource relative to a current state of data in one or more databases from which the content resource is generated is determined at 1004. This operation can include a determination of whether the backend server is capable of generating a more current version of the content resource than what can be displayed based on the cached resource. At 1006, the cached resource is updated by an asynchronous call to the backend server that occurs while the content resource based on the cached resource is displayed, and at 1010, the content resource 202 is replaced with a new version of the content resource 402 after completion of the asynchronous updating.

As noted above, the updating of the cached resource at 1006 can optionally occur upon receipt of a user interface input (e.g. a user selecting a manual reload user interface element 204) or automatically (e.g. as discussed above in reference to the semi-automatic and automatic approaches). Additionally, the replacing of the content resource 202 with the new version of the content resource 402 at 1010 can occur either automatically (e.g. as discussed above in reference to the automatic approach) or after receipt of a user interface input (e.g. a user selecting a refresh user interface element 602 as discussed above in reference to the semi-automatic approach).

As noted above, application cache, which is supported in newer programing languages for web applications (such as for example HTML5), can be used to store resources of Web applications or other networked applications at the client machine 102. This feature can thereby allow a developer to exert improved control over use of resources in the cache 120. As an example, in HTML5 a definition is maintained (e.g. via a cache manifest) of files that are not purged from the application cache 120, asynchronous updates of the application cache are possible, and programmatic control can be exerted over updating of screen contents from the cache.

If the server indicates that some of the resources are available in a more recent version, the client shows an indicator on the affected resources. When creating the Web application, the developer has the choice whether to have the affected resource being downloaded asynchronously and displayed immediately, downloaded asynchronously and displayed per the user's request, or both downloaded and displayed per the user's request. Additionally, the user may override the default behavior chosen by the developer using the personalization of the web page.

Implementations of the current subject matter can provide one or more advantages. For example, a user can perceive page as being complete and ready for viewing more quickly than using previously available approaches. Additionally, server loads can be reduced, for example by avoidance of unnecessary generation of images or other processor intensive tasks that would otherwise be necessary to fully generate page content. Additionally, network traffic can be reduced by loading such content to the client device only on demand or as needed. These features and/or others consistent with or similar to those described herein can also generally improve end user satisfaction and efficiency by providing shorter response times, in particular over relatively bandwidth constrained communication channels (e.g. those typically used by mobile devices such as smart phones, tablet computing devices, or the like).

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive trackpads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A computer program product comprising a machine-readable medium storing instructions that, when executed by at least one programmable processor, cause the at least one programmable processor to perform operations comprising:
displaying a content resource concurrently with an initial presentation of an application page at a client machine, the displaying comprising accessing a cached resource representative of the content resource, the cached resource being stored at the client machine, the content resource being provided by a backend server to the client machine based on data in one or more databases;
determining a validity of the cached resource relative to a current state of the data in the one or more databases;
updating the cached resource, the updating comprising an asynchronous call from the client machine to the backend server that occurs while the content resource based on the cached resource is displayed by the client machine as part of the application page, the updating occurring if the cached resource is determined to be invalid relative to the current state of the data; and
replacing the content resource with a new version of the content resource after completion of the asynchronous updating.

2. A computer program product as in claim 1, wherein the determining of the validity of the cached resource comprises determining whether the backend server is capable of generating the new current version of the content resource.

3. A computer program product as in claim 1, wherein the updating further comprises receiving the new version of the content resource.

4. A computer program product as in claim 1, wherein the cached resource comprises at least one of a previous version of the content resource downloaded to the client machine from the backend server during a previous display of the application page at the client machine, a blank shape, and a dummy image.

5. A computer program product as in claim 1, wherein the updating occurs in response to receipt of a user input or the updating occurs automatically upon determining that the cached resource is invalid relative to the current state of the data.

6. A computer program product as in claim 1, wherein the replacing occurs in response to receipt of a user input or automatically upon completion of the updating.

7. A system comprising:
at least one programmable processor; and
a machine-readable medium storing instructions that, when executed by the at least one processor, cause the at least one programmable processor to perform operations comprising:
displaying a content resource concurrently with an initial presentation of an application page at a client machine, the displaying comprising accessing a cached resource representative of the content resource, the cached resource being stored at the client machine, the content resource being provided by a backend server to the client machine based on data in one or more databases;
determining a validity of the cached resource relative to a current state of the data in the one or more databases;
updating the cached resource, the updating comprising an asynchronous call from the client machine to the backend server that occurs while the content resource based on the cached resource is displayed by the client machine as part of the application page, the updating occurring if the cached resource is determined to be invalid relative to the current state of the data; and
replacing the content resource with a new version of the content resource after completion of the asynchronous updating.

8. A system as in claim 7, wherein the determining of the validity of the cached resource comprises determining whether the backend server is capable of generating the new current version of the content resource.

9. A system as in claim 7, wherein the updating further comprises receiving the new version of the content resource.

10. A system as in claim 7, wherein the cached resource comprises at least one of a previous version of the content resource downloaded to the client machine from the backend server during a previous display of the application page at the client machine, a blank shape, and a dummy image.

11. A system as in claim 7, wherein the updating occurs in response to receipt of a user input or the updating occurs automatically upon determining that the cached resource is invalid relative to the current state of the data.

12. A system as in claim 7, wherein the replacing occurs in response to receipt of a user input or automatically upon completion of the updating.

13. A computer-implemented method comprising:
displaying a content resource concurrently with an initial presentation of an application page at a client machine, the displaying comprising accessing a cached resource representative of the content resource, the cached resource being stored at the client machine, the content resource being provided by a backend server to the client machine based on data in one or more databases;
determining a validity of the cached resource relative to a current state of the data in the one or more databases;
updating the cached resource, the updating comprising an asynchronous call from the client machine to the backend server that occurs while the content resource based on the cached resource is displayed by the client machine as part of the application page, the updating occurring if the cached resource is determined to be invalid relative to the current state of the data; and
replacing the content resource with a new version of the content resource after completion of the asynchronous updating.

14. A computer-implemented method as in claim 13, wherein the determining of the validity of the cached resource comprises determining whether the backend server is capable of generating the new current version of the content resource.

15. A computer-implemented method as in claim 13, wherein the updating further comprises receiving the new version of the content resource.

16. A computer-implemented method as in claim 13, wherein the cached resource comprises at least one of a previous version of the content resource downloaded to the client machine from the backend server during a previous display of the application page at the client machine, a blank shape, and a dummy image.

17. A computer-implemented method as in claim 13, wherein the updating occurs in response to receipt of a user input or the updating occurs automatically upon determining that the cached resource is invalid relative to the current state of the data.

18. A computer-implemented method as in claim 13, wherein the replacing occurs in response to receipt of a user input or automatically upon completion of the updating.

19. A computer-implemented method as in claim 13, wherein at least one of the displaying, the determining, the updating, and the replacing is performed by at least one programmable processor.
